(19) United States
(12) Patent Application Publication
(10) Pub. No.: US 2018/0293572 A1
(43) Pub. Date: Oct. 11, 2018

(54) SYSTEM AND METHOD FOR ADMINISTERING A USER ACCOUNT

(71) Applicant: MASTERCARD ASIA/PACIFIC PTE. LTD., Singapore (SG)

(72) Inventors: Benjamin Charles Gilbey, Singapore (SG); Naman Aggarwal, Singapore (SG); Ai Ling Felicia Choo, Singapore (SG)

(21) Appl. No.: 15/941,684

(22) Filed: Mar. 30, 2018

(30) Foreign Application Priority Data
Apr. 10, 2017 (SG) 10201702945V

(51) Int. Cl. G06Q 20/36; G06Q 20/40

(52) U.S. Cl. CPC G06Q 20/36; G06Q 20/401

(57) ABSTRACT

A system and a method for administering a user account are provided. The system includes at least one processor, and at least one memory including computer program code. The at least one memory and the computer program code are configured to, with the at least one processor, cause the system at least to receive from a device, a user account identifier, receive from a merchant device, a credit request including a merchant identifier and a credit amount, determine based on the user account identifier, at least one digital wallet associated with the user account identifier, and determine an amount of points to be credited to the user account associated with the at least one digital wallet, the user account being determined according to the user account identifier and the merchant identifier, and the amount of points being determined in response to the credit amount.

### CROSS-REFERENCE TO RELATED APPLICATION

This application is a U.S. National Stage filing under 35 U.S.C. § 119, based on and claiming benefits of and priority to Singapore Patent Application No. 10201702945V filed on Apr. 10, 2017. The entire disclosure of the above application is incorporated herein by reference for all purposes.

### TECHNICAL FIELD

The present invention generally relates to a system and method for administering a user account.

### BACKGROUND ART

Many transactions are conducted by a typical consumer on a daily basis using cash. In these transactions, the consumer often presents notes in exchange for goods and/or services. However, the value of the goods and/or services is often less than the value of the cash tendered in exchange. Thus, the consumer is often given change, and the amount is typically provided in small value denominations, usually in the form of notes and/or coins. If the consumer wishes to avoid given change in return, the consumer is required to tender the exact amount (in the form of notes and/or coins), or forgo the change. Moreover, as the value of the many transactions dealt with by the typical consumer on a daily basis is typically small (e.g. less than USD20), the consumer may face a mild reproach, or informal pressure from merchants if he/she is to present a payment card for such small value transactions. Thus, the consumer may ultimately opt either to carry change on a daily basis or forgo the change which the merchant returns to him/her. There are shortcomings to both approaches. The consumer would have either to carry around a cache of dense bulky coins or lose the change, which accumulates to a significant amount lost over time.

A merchant, especially one who deals with cash transactions on a regular basis, also encounters shortcomings when dealing with change. The merchant will incur administrative expenses associated with small-value denominations in the transactions with banks (e.g. coin/cash processing services), as the merchant would have to keep a ready supply of small denominations in the form of notes and coins for transactions with consumers. The merchant also incurs accounting expenditures associated with small value denominations as the time and manpower have to be spent to keep track and account for coins/notes in the transactions with consumers.

Conventional systems, specifically those belonging to merchants, typically lack capabilities that can capture, analyze, communicate, or use transaction data in a contextually-meaningful, comprehensive, and efficient manner. Further, conventional systems are often limited to specific individual purposes or uses, demanding that users (for example, merchants) invest in multiple systems in order to perform different activities (for example, an accounting solution to capture transaction data and a customer resource management solution for monitoring and recording loyalty points). Although a wide range of data and information is available, conventional systems and methods fail to provide effective solutions that comprehensively capture data.

Accordingly, what is needed is a method for administering a user account that seeks to address some of the above problems. Furthermore, other desirable features and characteristics will become apparent from the subsequent detailed description and the appended claims, taken in conjunction with the accompanying drawings and this background of the disclosure.

### SUMMARY

A first aspect of the present disclosure provides a system configured to administer a user account. The system includes at least one processor, and at least one memory including computer program code. The at least one memory and the computer program code are configured to, with the at least one processor, cause the system at least to, receive from a device, a user account identifier, receive from a merchant device, a credit request including a merchant identifier and a credit amount, determine based on the user account identifier, at least one digital wallet associated with the user account identifier, and determine an amount of points to be credited to the user account associated with the at least one digital wallet, the user account being determined according to the user account identifier and the merchant identifier, and the amount of points being determined in response to the credit amount.

The system may be further configured to receive a user selection of the at least one digital wallet and/or the user account.

The system may be further configured to credit the determined points to the user account.

The system may be configured to, in determining the points to be credited, send a verification request to the device, the verification request requesting a verification input, receive the verification input in response to the verification request from the device, and compare the received verification input with registration data that has been registered for the at least one digital wallet and/or the user account, wherein the step of crediting the determined points to the user account is performed in response to a result of the comparison step.

The system may be configured to, in receiving the verification input, receive the verification input from the merchant device, the verification input including any one or more of: a user identification code and a one-time password generated by the device using at least the user account identifier.

The system may be configured to credit the determined points to the user account responsive to the received verification input matching the registration data.

The system may be further configured to send a failure message to a device responsive to the received verification input not matching the registration data.

The system may be further configured to transmit a credit message to the device, the credit message indicative of the points credited to the user account.

A second aspect of the present disclosure provides a method for administering a user account. The method includes receiving from a device, a user account identifier, receiving from a merchant device, a credit request including a merchant identifier and a credit amount, determining based on the user account identifier, at least one digital wallet associated with the user account identifier, and determining an amount of points to be credited to the user account associated with the at least one digital wallet, the user account being determined according to the user account identifier and the merchant identifier, and the amount of points being determined in response to the credit amount.

The method may further include receiving a user selection of the at least one digital wallet and/or the user account.

The method may further include crediting the determined amount of points to the user account.

The step of determining the amount of points to be credited may include sending to the device, a verification request, the verification request requesting a verification input, receiving from the device, the verification input in response to the verification request, and comparing the received verification input with registration data that has been registered for the at least one digital wallet and/or the user account, wherein the step of crediting the determined points to the user account is performed in response to a result of the comparison step.

The step of receiving the verification input may include receiving, from the merchant device the verification input, the verification input including any one or more of: a user identification code and a one-time password generated, by the device, using at least the user account identifier.

The step of crediting the determined amount of points to the user account may be performed responsive to the received verification input matching the registration data.

The method may further include sending a failure message to a device, responsive to the received verification input not matching the registration data.

The method may further include transmitting to the device, a credit message indicating the amount of points that have been credited to the user account.

The step of transmitting the credit message may include transmitting the credit message via a near field communications link through the merchant device.

A third aspect of the present disclosure provides a non-transitory computer readable medium having stored thereon an application which when executed by a computer causes the computer to perform steps including, receiving from a device, a user account identifier, receiving from a merchant device, a credit request including a merchant identifier and a credit amount, determining based on the user account identifier, at least one digital wallet associated with the user account identifier, and determining an amount of points to be credited to a user account associated with the at least one digital wallet, the user account being determined according to the user account identifier and the merchant identifier, the amount of points being determined in response to the credit amount.

### BRIEF DESCRIPTION OF DRAWINGS

Embodiments of the invention will be better understood and readily apparent to one of ordinary skill in the art from the following written description, by way of example only, and in conjunction with the drawings, in which:

FIG. 1 shows a flowchart illustrating a method for administering a user account in accordance with embodiments of the invention.

FIG. 2 shows a schematic diagram of a transaction system with a point management system, in accordance with embodiments of the invention associated with server-administered user account.

FIG. 3 shows a schematic diagram of a transaction system with a point management system, in accordance with embodiments of the invention associated with client-administered user account.

FIG. 4 shows a schematic diagram of a transaction system in accordance with an embodiment of FIG. 3.

FIG. 5 shows a schematic diagram of a transaction system in accordance with another embodiment of FIG. 3.

FIG. 6 shows a schematic diagram of a system configured to facilitate the management of the points in accordance with embodiments of the invention.

FIG. 7 shows a schematic of a computing device used to realise the point management system of FIGS. 2 and 3.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DESCRIPTION OF EMBODIMENTS

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other computing device selectively activated or reconfigured by a computer program stored therein. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on a computer effectively results in an apparatus that implements the steps of the preferred method.

In embodiments of the present invention, use of the term ‘server’ may mean a single computing device or at least a computer network of interconnected computing devices which operate together to perform a particular function. In other words, the server may be contained within a single hardware unit or be distributed among several or many different hardware units.

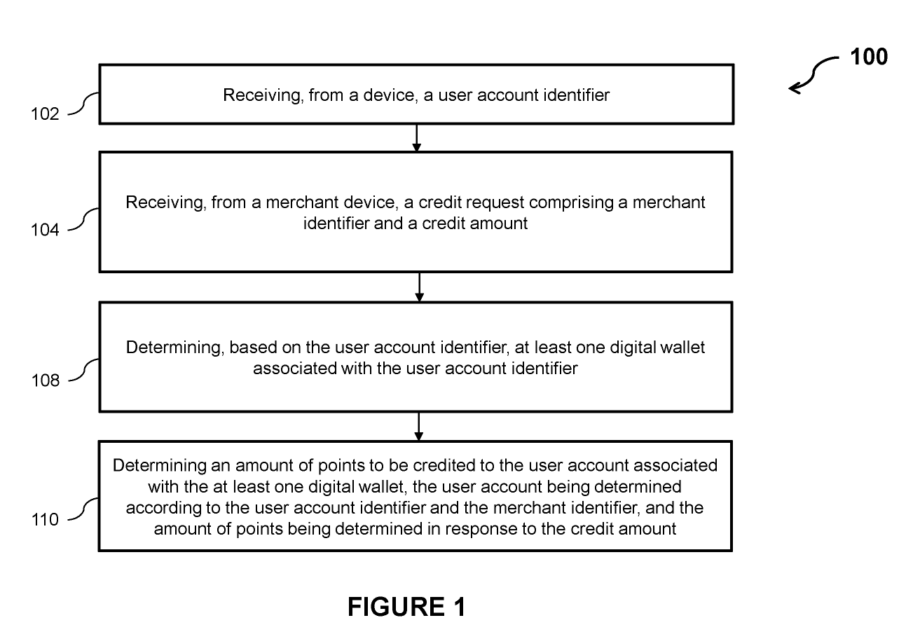

Such a server may be used to implement the method 100 shown in FIG. 1. FIG. 1 shows a flowchart illustrating a method 100 for administering a user account in accordance with embodiments of the invention. The method 100 can comprise crediting a user account with points during processing of transactions conducted on a regular basis by consumers. Such transactions can involve the supply of goods and/or services by a merchant to a consumer as a result of a purchase (e.g. one that is an acquisition with cash) or other arrangement. In other words, the transactions may include, but are not limited to transactions initiated with cash in exchange for goods and/or services (also referred to as “product”) and where the value of the goods and/or services is often less than the value of the cash tendered in exchange, such that change is conventionally returned in the form of notes and/or coins to the consumer. In embodiments of the present invention, the change is instead credited to a user account in the form of points (e.g. loyalty points), thus facilitating transactions by alleviating the need for consumers and merchants to handle change which is usually in small denominations. Further, the method 100 can be implemented on either client-side or server-side digital wallets. The client-side and server-side digital wallets also comprise client-administered and server-administered user accounts. Thus, embodiments of the present invention can advantageously reduce the need for the merchants to return cash, and for the consumers to accept cash as the balance of the sum paid in exchange for goods and/or services. More advantageously, embodiments of the present invention can promote displacement of cash in consumer transactions, particularly in small-value transactions; foster gradual changes in consumer behaviour with regards to digital currencies and facilitate the transition to a cashless society. The benefits of the present invention for the merchants may also include reduced transactional, administrative and operating expenses, greater consumer retention and loyalty, in addition to other advantages that are elaborated below. Further, in some embodiments, references to a merchant may mean one or more merchants, the merchants being affiliated or partnered with one another, or casually linked by a common merchant category for purposes of the method 100.

Embodiments of the present invention can advantageously provide a simplified and streamlined system and method to merchants. Various embodiments provide a system and method that possess capabilities that can capture, analyze, communicate, or use transaction data in a contextually-meaningful, comprehensive, and efficient manner. Instead of using multiple systems to record a transaction and subsequently, credit points to a user, it is possible to use a single system according to various embodiments to perform this function. Advantageously, the system according to various embodiments comprehensively captures data effectively, thereby reducing processing time among multiple systems.

The method 100 for administering a user account broadly includes:
step 102: receiving from a device, a user account identifier
step 104: receiving, from a merchant device, a credit request comprising a merchant identifier and a credit amount
step 106: determining, based on the user account identifier, at least one digital wallet associated with the user account identifier
step 108: determining an amount of points to be credited to the user account associated with the at least one digital wallet, the user account being determined according to the user account identifier and the merchant identifier, the amount of points being determined in response to the credit amount.

For various embodiments, a consumer is one who initiates a transaction and a merchant is one with whom the customer initiates the transaction. The consumer may identify and use a user account for which he may or may not be an owner in the transaction. In other words, the consumer may not be the true owner (e.g. the rightful owner) of the user account. For various embodiments, the administration of the user account comprises crediting the determined amount of points to the user account. The administration of the user account may also include updating registration data that has been registered for the user account and debiting an amount of points from the user account in response to a user request.

At step 102, the method 100 includes receiving the user account identifier from the device. The user account identifier generally includes data identifying the user account to be used for purposes of administering the user account. The user account identifier can also include data identifying the at least one digital wallet, which comprises the user account. It can be appreciated that in embodiments, the data identifying the at least one digital wallet may be also used to identify the user account. The data may include a user identification code which comprises any one or more of registration data that has been registered for the user account.

The registration data may include an account number, name of the user account holder, email address of the user account holder, mobile number of the user account holder and/or a primary account number (PAN).

The PAN refers to a number of digits (or characters) which identify an account issued by an issuing party (for example, a bank). For example, in some embodiments an account (e.g. credit account, debit account, pre-paid account) is issued by an issuing party pursuant to MasterCard® International Incorporated rules, and the PAN may be a thirteen to nineteen-digit string, usually sixteen digits, that identifies both the issuing party (e.g. which may be based on the first few digits of the string, for example, the first five to ten digits) and the specific account (e.g. which may be based on some or all of the remaining digits). The PAN may also identify if the owner is subscribed to a transaction service such as one that determines points to credit to the account based on a credit amount. In an embodiment, the service may underlie the existing authentication programs to authenticate an owner for a merchant during a transaction. The PAN can be utilized to route and process transactions that involve the account. Those skilled in the art will appreciate that other primary account schemes and formats may be used in conjunction with embodiments described herein.

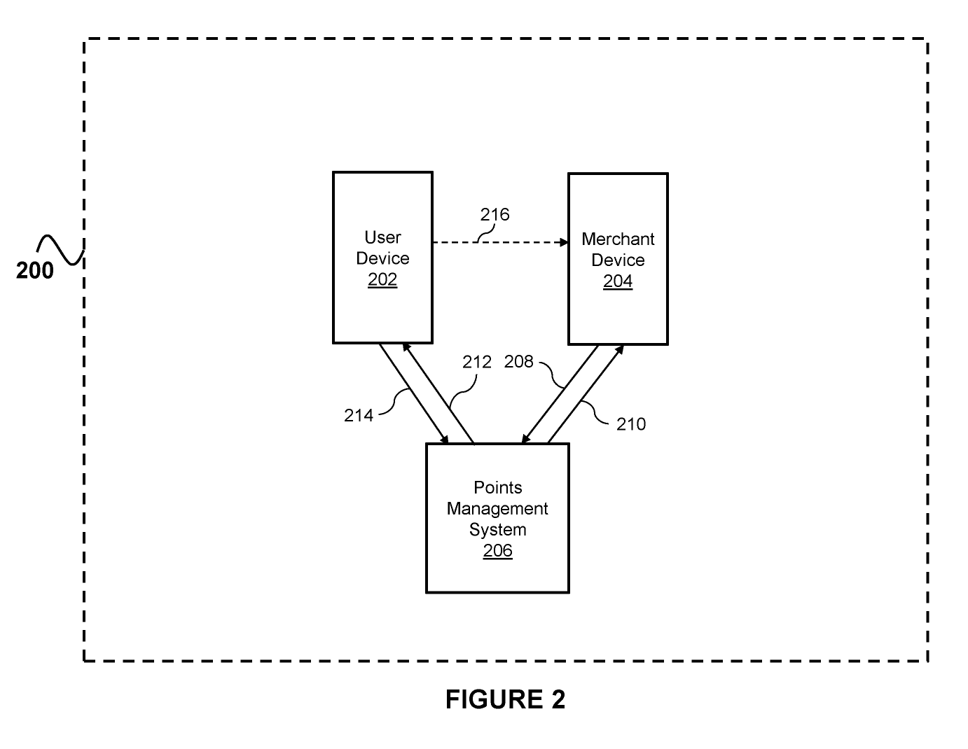

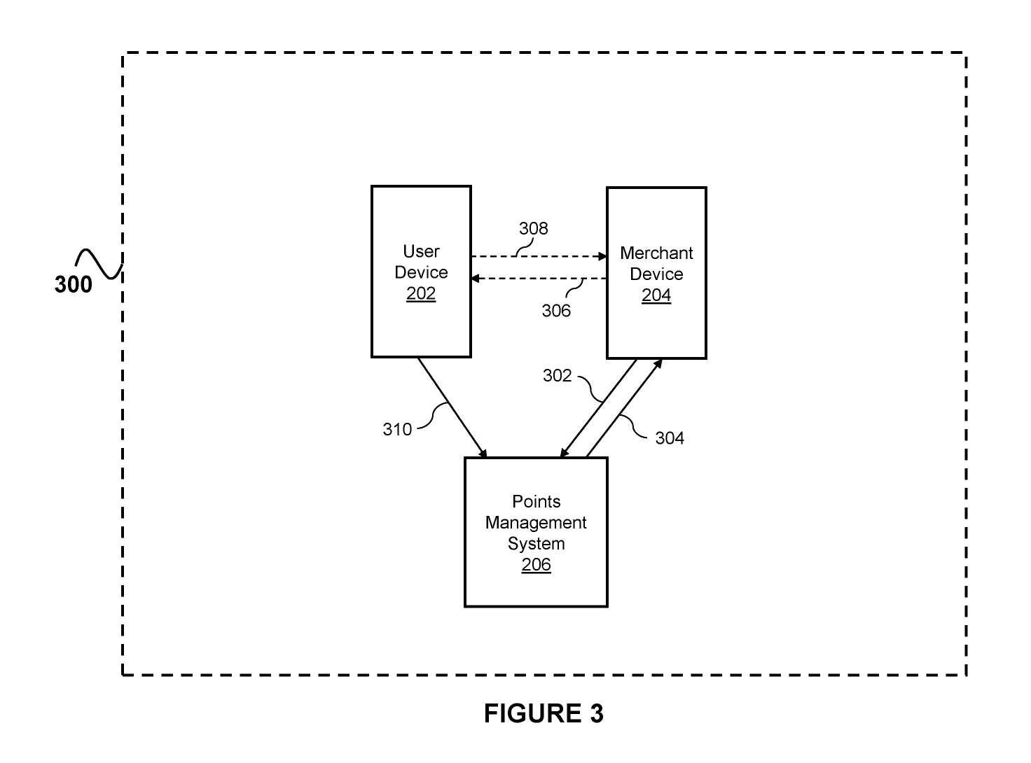

As will be described in more detail later, in an embodiment, the device from which the user account identifier is sent may be a merchant device 204 (more details will be provided in FIGS. 2 and 3). For example, the user account identifier may be provided verbally by the consumer, which is then inputted into the merchant device 204. In another embodiment, the device may be a user device 202 (see FIGS. 2 and 3). The user account identifier may be a unique one-time password associated with the user account and generated by the user device.

Alternatively, the user account identifier may originate from the user device 202 and routed through the merchant device 204, which acts to request an authorising party (e.g. point management system 206) before being received. Routing means may include wireless communication means such as near-field communication, in which the user account identifier is sent from the user device 202 to the merchant device 204.

At step 104, the method 100 includes receiving the credit request from the merchant device. The credit request may be generated by the merchant device 204 and can include at least the merchant identifier and the credit amount. In an embodiment, the credit request may be generated by the merchant device 204 in response to input of the credit amount.

In an alternate embodiment, the credit request may be generated by merchant device 204 in response to input of a transaction amount and a payment amount, and the credit amount may be calculated as the difference between the transaction amount and the payment amount.

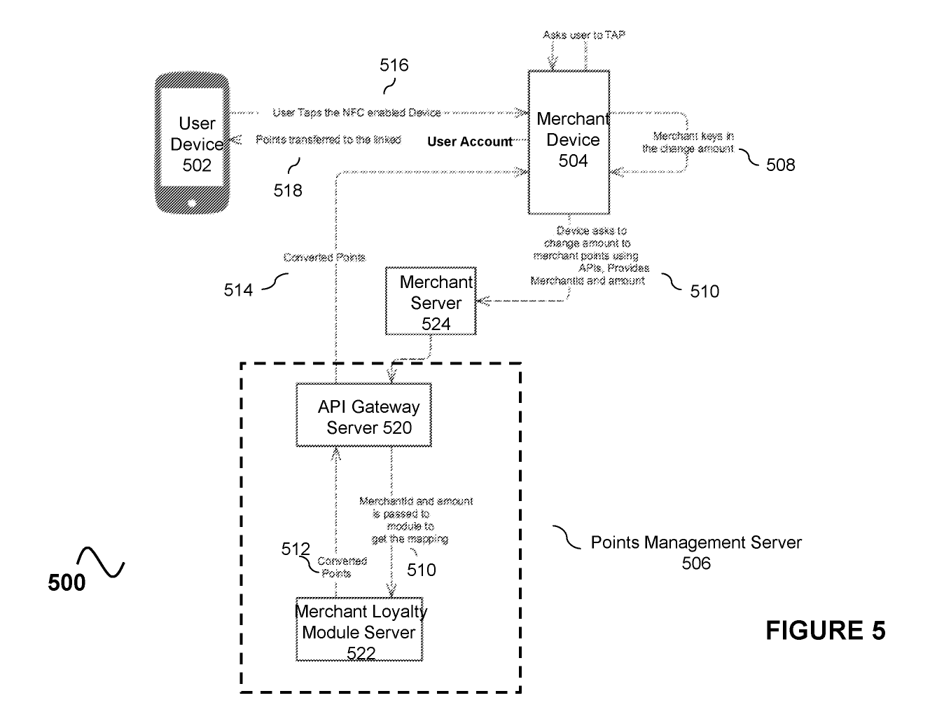

The transaction amount is an amount that is associated with a value of goods and/or services (also referred to as a product) that have been transacted, and the payment amount is an amount (i) that has been received for a product and (ii) that is equal to or more than the transaction amount. In other words, the transaction amount is an amount that is associated with the retail price of the goods and/or services provided by the merchant and the payment amount is an amount that is tendered in cash by the consumer in exchange for the goods and/or services. Further, the credit request may further comprise payment amount data and transaction amount data, in addition to the credit amount. The merchant device 204 is commonly known as a transaction acquiring device, and may be a point-of-sale (POS) terminal or a cash register that is connected remotely to either a merchant server 522 (FIG. 5) or a points management system 206 (FIG. 2). The merchant device 204 may also have one or more add-ons which enables the merchant device to communicate with the user device 202 and the points management system 206 through wired and/or wireless communication means e.g. near-field communications. In alternate embodiments, the merchant device 204 can be a laptop, a tablet or a smartphone having a operating system hosting one or more mobile applications that is configured to communicate directly with the user device 204 and the points management system 206. The merchant identifier generally includes data identifying the merchant account associated with the transaction. The data identifying the merchant can include a merchant identification number (MID), a business name, and/or tax registration number of the business. The merchant identifier may be used on one or more merchant devices. For example, for merchant devices that are registered to the same merchant, the same merchant identifier may be used. Additionally, or alternatively, a merchant identifier may be related to an address registered to a merchant and all devices sharing the same address may use the merchant identifier.

For example, the merchant may be a coffeehouse operator, and sells espresso at the retail price of USD7.50. The consumer has purchased an espresso and has tendered a ten-dollar bill in exchange for the product. In this example, the transaction amount is USD7.50 and the payment amount is USD10, and the transaction and payment amounts are inputted into the merchant device. The credit request is then generated by the merchant device and the credit amount (which is the difference between the payment amount and the transaction amount) is USD2.50. The credit request is subsequently sent from the merchant device and comprises at least the merchant identifier and the credit amount of USD2.50.

In alternate embodiments, the credit amount may be equal to the payment amount. In other words, the transaction amount may be zero for the current transaction, and deferred to a later date. Such alternate embodiments include the purchase of stored-value vouchers (e.g. gift vouchers or gift cards) by consumers. The stored-value vouchers are redeemable at the relevant retail premises at a later date. Thus, the credit request that would be generated by the merchant device used in the transaction would include the merchant identifier and the credit amount. The credit amount is equivalent to the payment amount, which is associated with the value of the stored-value vouchers. Advantageously, the stored-value vouchers in embodiments of the present invention can be electronic vouchers, which allow a consumer to redeem the value of the electronic voucher in credit amount.

In another embodiment, the credit amount may be a portion of the change (i.e. the balance of the sum paid in exchange for the goods and/or services provided by the merchant). In other words, the change may be proportioned or to be separated into a cash component and a credit component. The cash component may be returned to the consumer while the remaining is associated with the credit amount. The cash component may be returned to the consumer in the form of banknotes. Using the espresso example above, the consumer may request that the change of USD3.50 be separated into the cash component of USD2.00, and the credit amount of USD1.50. The cash component and the credit amount can be inputted into the merchant device, along with the payment and transaction amount. Thus, the credit request which would be sent from the merchant device includes USD1.50 as the credit amount. Advantageously, the consumer retains the choice of obtaining the change in banknotes, while avoiding the receipt of coins or forfeit of the change.

At step 106, the method 100 includes determining, based on the user account identifier, at least one digital wallet associated with the user account identifier. As will be elaborated in greater detail later, the at least one digital wallet can be a client-side and/or server-side digital wallet. The client-side and server-side digital wallets can include at least one client-administered and at least one server-administered user account respectively.

At step 108, the method 100 includes determining an amount of points to be credited to the user account associated with the at least one digital wallet. The user account is determined according to the user account identifier and the merchant identifier, and the amount of points is determined in response to the credit amount. In other words, the user account to be credited is determined based on the user account identifier and the merchant identifier. For example, the user account may be identified using the user account identifier, and the user account is associated with the at least one digital wallet. Each user account may be associated with a merchant, or a merchant category associated with the merchant identifier, is identified using the merchant identifier. In an embodiment, the step 108 includes a step of comparing the payment amount and the transaction amount so as to determine and verify the difference between the payment amount and the transaction amount.

In various embodiments, the user account identifier may be associated with one or more digital wallets and/or one or more user accounts. Thus, the method 100 can further comprise sending a request for a user selection of the at least one digital wallet and/or the user account to which the determined amount of points is credited. The method 100 can also further comprise receiving a user selection of the at least one digital wallet and/or the user account.

The amount of points to be credited to the user account may be equivalent to the credit amount indicated in the request sent from the merchant device, or subject to a multiplier determined in response to the merchant identifier and the credit amount. For example, the merchant identifier can be used to identify merchants that are enrolled in different conversion arrangements (described below) that may be available with the transaction settlement method 100. For example, the conversion of the credit amount to the points may be based on a predetermined conversion ratio. Conversion ratios may differ depending on the particular merchant identifiers. The conversion ratio can be, for example 1:1 or 1:10, representing a ratio of credit amount to points to be converted based on the corresponding conversion ratio. That is, each credit amount can be converted into 1 point or 10 points. The ratios may be further determined based on the credit amount, such that the higher ratios are applied for larger credit amounts. For example, the ratio of 1:1 may apply to credit amounts below USD3.00, and a ratio of 1:1.2 may apply to credit amounts above USD3.00. In such embodiments, the tiered conversion ratios can advantageously encourage consumers to convert most, if not all of their change (e.g. credit amount) in a transaction to points. Once the amount of points is determined, the points are credited to the user account. The crediting of the user account may include increasing user account index. Thus, various embodiments of the present invention can facilitate transaction settlement since the change is credited to a user account in form of points instead of cash, thereby advantageously alleviating the need for consumers and merchants to handle the change which is usually in small denominations. Moreover, in various embodiments, the consumer can use the points to offset future purchases at the merchant. The merchant may also run promotions catered to consumers who credit points to the user account, and to consumers who uses such points in their purchases to foster customer loyalty.

The step 108 can further include an authentication step. The purpose of the step is to verify if the consumer is the holder of the at least one digital wallet and/or the account. The authentication step can include (i) sending to the device a verification request asking for a verification input, (ii) receiving the verification input from the device in response to the verification request and (iii) comparing the received verification input with a registration data that has been registered for the at least one digital wallet and/or the user account.

In an embodiment, the verification request may or may not be in the same format as the credit request. That is, the verification request may be an in-band or out-of-band message. An out-of-band message refers to a message that is sent via a communication path, type or protocol which is different to the current communication path, type or protocol. Therefore, if message flow (e.g., credit request) thus far has been via the Transmission Control Protocol/Internet Protocol (TCP/IP), the verification request may be sent via SMS so as to be an out-of-band message. In other words, an out-of-band message typically makes use of two separate networks which work simultaneously to authenticate a user. For example, a fraudulent user may initiate a transaction via a first network and the owner of the digital wallet and/or the account will be informed of such a transaction via a second network. This provides an opportunity to the owner of the digital wallet and/or the account to stop the transaction. Advantageously, an out-of-band message may be used to authenticate a customer even if a fraudulent user gains access to an owner's digital wallet and/or account.

The step of crediting the determined points to the user account is performed in response to a result of the comparison step. In an embodiment, the determined points are only credited responsive to the received verification input matching the registration data. For example, matching of the received verification input with the registration data may include comparing the verification input to the registration data. In an embodiment, the verification request may request that the first, third and sixth characters of the registration data be inputted. In this case, the input is then compared to the appropriate portions of the registration data. In an embodiment, an indication, which is based on the comparison between the verification input and the registration data, is included in a response message. In other words, the verification input may match the registration data even when a portion of the verification input corresponds to the registration data. The indication is used to indicate whether the consumer is the owner of the account. For example, the indication may be “Y” or “Yes” if the verification input matches or corresponds to the registration data. The indication may be “N” or “No” if the verification input does not match or correspond to the registration data. The indication may be “U” or “Un-contactable” if no verification input is received.

The verification input may include the user identification code and/or a one-time password generated by the device using at least the user account identifier. The user identification code can be the registration data that is not used in the user account identifier. For example, the verification input can be the mobile number or the identification number (e.g. social security number) of the user account holder. The verification input can also be a PIN number, or a two-part authentication code comprising the PIN number and the one-time password. The one-time password may be generated by the device, or sent to the device via a communication network. As will be described in more detail later, in embodiments, the verification input can be sent from the user device 202 (FIG. 3). In other embodiments, the device can be the merchant device 204 (FIG. 2). It can be appreciated that the verification input may originate from the user device 202 and routed through the merchant device 204 before being received. In other words, the authentication step may be performed at the merchant device 204, or the points management system 206, depending on the type of digital wallet (e.g. client-side or server-side) and the specific implementation. Thus, it can also be appreciated that the authentication step may be performed at different stage of the transaction process. For example, the authentication step can be performed upon generation of the credit request, receipt of the credit request (i.e. before the credit amount is converted into points) or after the points are determined.

The method 100 may also include transmitting to a device a credit message indicating the amount of points that have been credited to the user account. The device may be the same device to which the verification request is sent, such as the user device 202. Alternatively, the device may be a separate device which the user has designated. For example, in embodiments associated with client-based digital wallets, the amount of points to be credited to the user account and the credit message can be sent to the same device (e.g. the user device 202). The credit message and the amount of points can be transmitted via wireless means from the merchant device 204 to the user device 202. For example, the transmission of the credit message can include transmitting the credit message via a near field communications link through the merchant device. A notification account may be further designated to receive the credit message as well. The notification account may be an email account or a mobile number that has been registered for the user account. In embodiments associated with server-based digital wallets, the credit request may be sent to the points management system 206, while the credit message may be sent to the user device 202 and/or the notification account.

If the received verification input fails to match the registration data, a failure message can also be sent to the same device as mentioned above, the message can indicate that the received verification input does not match the registration data. In other words, the method 100 can further include sending a failure message responsive to the received verification input not matching the registration data.

FIG. 2 shows a schematic diagram of a transaction system 200 with a point management system 206, in accordance with embodiments of the invention. The transaction system comprises the user device 202, the merchant device 204 and the points management server 206. In various embodiments of the present invention, each of the user device 202, the merchant device 204 and the points management server 206 may be in direct communication with the other two components of the transaction system 200. For example, the user device 202 is in direct communication with the merchant device 204, and the points management server 206. Communication means include wired and wireless communication means such as cable or fibre-optic communications, near-field communication and wireless mobile communications (e.g. 3G, 4G networks).

The user device 202 is typically associated with a consumer who initiates a financial transaction at a retail location, where the merchant device 204 is located. The user device 202 may be for example, a mobile terminal such as a laptop computer, smartphone, smartwatch or a tablet with a mobile operating system, such as Windows of Microsoft, iOS of Apple Inc. or Android of Google Inc. The user device 202 is associated with at least one client-based and/or server-based digital wallet. The at least one client-based and/or server-based digital wallet may comprise one or more user accounts.

In embodiments associated with server-based digital wallets, the operating system may similarly host one or more mobile applications. The one or more mobile applications may be similar to the one or more mobile applications in embodiments associated with client-based digital wallets. However, the at least one digital wallet and the user account are not managed locally on the user device 202. Rather, the server manages the at least one digital wallet and the user account. The one or more mobile applications include a digital wallet and user account information component which can synchronize user account information with a server (i.e. points management server 206).

Embodiments associated with server-based digital wallets are now described in detail. The transaction settlement includes several stages that occur to cause the determined amount of points to be credited to the user account. In various embodiments, the transaction settlement is initiated with a request for points to be credited to a designated user account.

The transaction settlement is initiated with the receipt of either the user account identifier, or the credit request by the points management server 206 from a device. As mentioned above, the user account identifier may originate from the merchant device 204 or the user device 202. The credit request may originate from the merchant device 204.

For example, in a first embodiment, the user account identifier is provided verbally by the consumer, which is then inputted into the merchant device 204. The user account identifier may alternatively be provided in a message 217 sent from the user device 202 to the merchant device 204 via the wireless communication means. The user account identifier is then sent by the merchant device 204 to the points management server 206 in a credit request 208. The credit request 208 also includes the merchant identifier and the credit amount. Upon receipt of the credit request 208, the points management system 206 may then send a verification request 212 to the user device 202. The points management system 206 will then receive the verification input 214 from the user device 202, compare the received verification input with the registration data that has been registered for the user account, and determine and credit the amount of points to the user account identified by the user account identifier and the merchant identifier based on the credit amount. The points management system 206 then sends a credit message 210 indicating the amount of points that have been credited to the user account to the merchant device 204. The points management system 206 may also send a separate credit message (not shown) to the user device 202, or a separate notification account designated by the user. That is, the credit message may be sent to a notification account that is different from the user account.

Alternatively, in a second embodiment, the user account identifier need not be included the credit request 208. In other words, the user account identifier need not be provided by the user to the merchant, and the credit request 208 does not include user account information. Upon receipt of the credit request 208 from the merchant device 204, the points management system 206 sends a message 212 including a user account identification request to the user device 202. The user device then sends a reply 214 including the user account identifier in response to the message 212. Once the user account identifier is received, the points management system 206 proceeds to determine and credit the amount of points to the user account identified by the user account identifier and the merchant identifier based on the credit amount. The points management system 206 may also include a verification request in the message 212. The reply 214 may also include a verification input in response to the verification request.

Embodiments associated with client-based digital wallets are now described in detail with reference to FIG. 3. FIG. 3 shows a schematic diagram representing a general transaction system 300 associated with client-based digital wallets. Similar to server-based digital wallets, the transaction settlement includes several stages that occur to cause the determined amount of points to be credited to the user account. However, as the user account and the user account information are managed locally on a client device (e.g. the user device 202), there exist differences in the flow of information between the user device 202, the merchant device 204, and the points management system 206.

In embodiments associated with client-based digital wallets, the operating system of the user device 202 may host one or more mobile applications, where the one or more mobile applications manages the at least one digital wallet, the user account identifier and the user account, each user account being associated with a merchant, or a merchant category. In other words, user account information is stored on the client side (i.e. the user device 202) which can initiate communication with the merchant device 204 and the points management system 206.

The transaction settlement is initiated with a credit request 302 from the merchant device 204. The credit request 302 comprises the merchant identifier and the credit amount. The credit request 302 is received by the points management server 206, which then determines an amount of points based on the merchant identifier and the credit amount. The points management server 206 subsequently sends a message 304 to the merchant device 204. The message 304 comprises at least the determined amount of points to be credited to the user account, the merchant identifier and the credit amount. The user device 202 then initiates communication with the merchant device 204, and the merchant device 204 then modifies the message 304 for device-to-device communication and routes a modified message 306 to the user device 202. The user device 202 then credits the amount of points contained in the modified message 306 to the user account identified by the user account identifier and the merchant identifier. Specifically, the at least one digital wallet may comprise a plurality of user accounts and the relevant user account associated with the merchant identifier is updated with the amount of points. The user device 202 may also send messages 308, 310 to the merchant device 204 and the points management 206 respectively. The messages 308, 310 may contain information about total points in the user account and/or updated user information. The merchant device 204 and the points management system 206 may then use information contained in the messages 308, 310 and update their databases accordingly.

Further, prior to routing of the modified message 306 to the user device 202, the merchant device 204 may request the user device 202 to transmit a user account identifier. The merchant device 204 may further request a verification input from the user device 202, upon receipt of the user account identifier by sending a verification request (not shown). The merchant device 204 may then compare the received verification input with user account information that is maintained on one or more servers connected to the merchant device 204, or communicate with the points management system 206 before sending the modified message 306 to the user device 202.

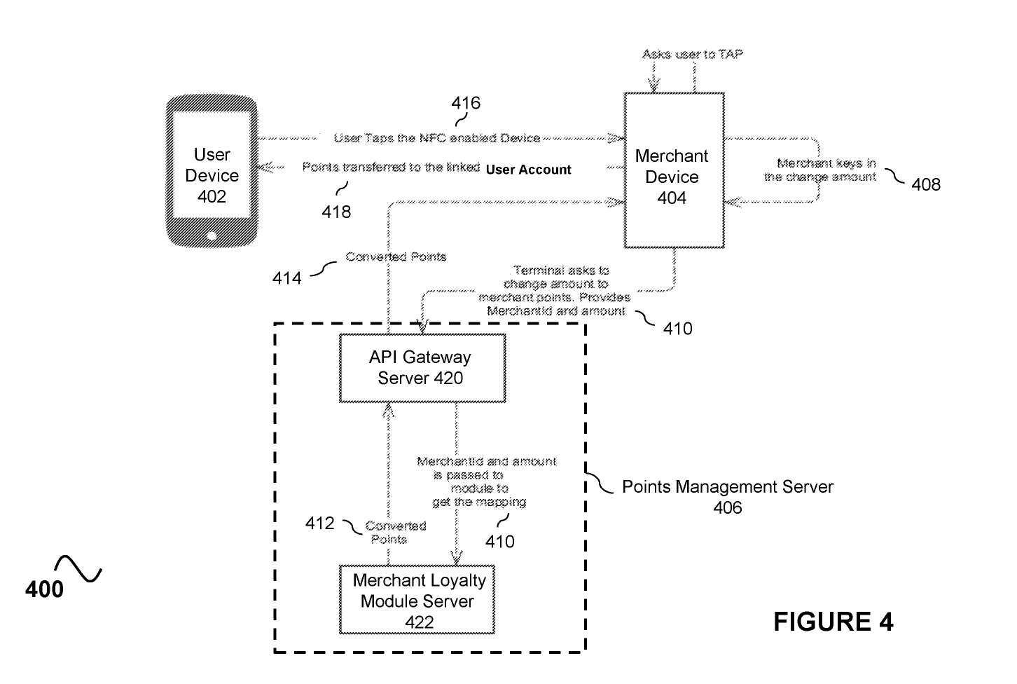

FIGS. 4 and 5 each shows a schematic diagram of transaction systems 300, 400 implemented in accordance with embodiments of the invention associated with client-administered user account.

In the transaction system 400, the merchant device 404 is a point-of-sale (POS) terminal which has been modified to enable the merchant device 404 to communicate directly with both the user device 402 and the points management system 406 through wired and/or wireless communication means e.g. near-field communications without use of external add-ons.

In the transaction system 500, the merchant device 504 is a device separate from the conventional point-of-sale (POS) terminal installed on the merchant's premises. The merchant device in transaction system 500 can be a laptop, a tablet or a smartphone having a operating system hosting one or more mobile applications that is configured to communicate directly with the user device 502 and the merchant server 524.

The merchant device 404, 504 of the transaction system 400, 500 can accept input 408, 508 of a credit amount. In the transaction system 400, the merchant device 404 forwards a credit request 410 to points management server 406, while in the transaction system 500, the merchant device 504 forwards a credit request 510 to the merchant server 524. The merchant server 524 can record the credit request 510, modify the credit request 510 to a format compatible with the points management server 506, and forward the modified credit request to points management server 506. Thus, it can be appreciated that the points management servers 406, 506 are similar, and that the transactions systems 400, 500 are different options that merchants can adopt, depending on their preference.

The credit request 410, 510 comprises the credit amount and merchant identifier. The points management server 406, 506 comprises API (Application Program Interface) gateway server 420, 520 and merchant loyalty module server 422, 522. The API gateway server 420, 520 manages incoming credit requests, including the acceptance, processing, monitoring and access control of the credit requests. The API gateway server 420, 520 receives the credit request 410, 510, records the credit request 410, 510 and routes the recorded credit request 410, 510 to the merchant loyalty module server 422, 522. The merchant loyalty module server 422, 522 then determines an amount of points based on the merchant identifier and the credit amount, and forwards a message 412, 512 containing the determined amount of points to the API gateway server 420, 520. The API gateway server 420, 520 records and if necessary, modifies the message 412, 512 and routes the modified message 414, 514 to the merchant device 404, 504. As described above, the user device 402, 502 can link with the merchant device 404, 504 via wireless communication 416, 516, and the merchant device 404, 504 can transfer a message 418, 518 to the user device 402, 502, the message 418, 518 containing the determined amount of points and the merchant identifier. The user device 402, 502 then credits the amount of points contained in the message 418, 518 to the user account identified by the user account identifier and the merchant identifier.

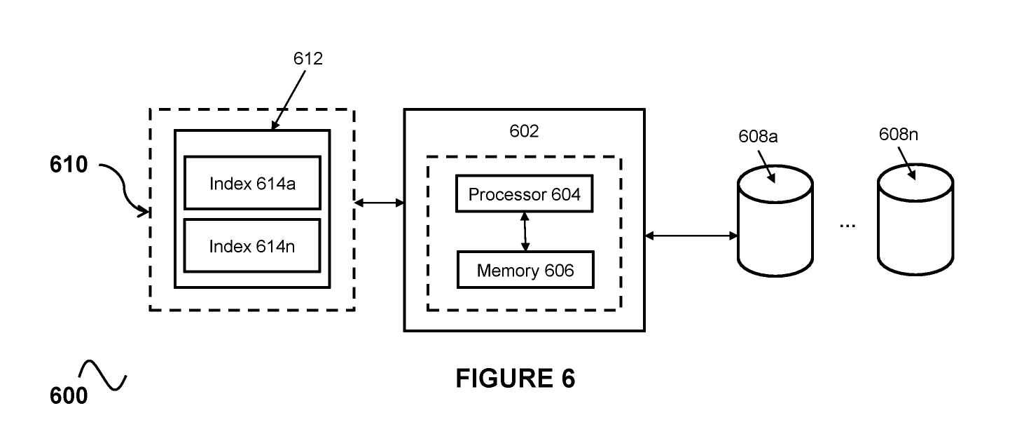

FIG. 6 shows a schematic diagram of a system 600 configured to facilitate the management of points in accordance with embodiments of the invention. The system 600 comprises a computing device 602, one or more databases 608a . . . 608n associated with one or more user accounts and a mobile application 610 associated with at least one digital wallet. The computing device 602 may be a component of the point management system 206 (FIG. 2), and the mobile application 610 may be running on the user device 202 (FIG. 2).

The mobile application 610 can directly communicate with the computing device 602. The mobile application 610 is typically associated with a consumer who manages the one or more user accounts. The mobile application 610 can also comprise a points management application which the consumer can use to access one or more of his user accounts shown on user input interface 612. For example, the consumer may be able to see, using the mobile application 610 on the user device 202, the user accounts indexes 614a . . . 614n. Each user accounts index 614a . . . 614n may be associated with a merchant, or a merchant category, and synchronised with databases 608a . . . 608n. The databases 608a . . . 608n may be stored natively on the user device 202, or on one or more servers connected to the point management server 206 and/or the merchant device 204.

The one or more databases 608a . . . 608n store information about the relevant digital wallet and associated user accounts. For example, with the consumers' consent, the stored information may comprise aggregate data such as purchase information, spending behaviour, and preferences of the consumers. In embodiments, the stored information can be relayed to merchants who would be able to use the stored information, together with the loyalty index, to tailor marketing offers for select consumer categories. Further, the consumer may also see benefits, promotions and items that can be redeemed through the mobile application 610.

In embodiments of the invention, the memory 606 and the computer program code, with processor 604, are configured to cause the computing device 602 to (i) receive, from a device, a user account identifier from a device, (ii) receive, from a merchant device, a credit request comprising a merchant identifier and a credit amount from a merchant device as at least part of transaction settlement, the credit request comprising a merchant identifier and a credit amount, (iii) determine, based on the user account identifier, at least one digital wallet associated with the user account identifier, and (iv) determine an amount of points to be credited to a the user account associated with the at least one digital wallet, the user account being identified by determined according to the user account identifier and the merchant identifier, and the amount of points being determined in response to the credit amount.

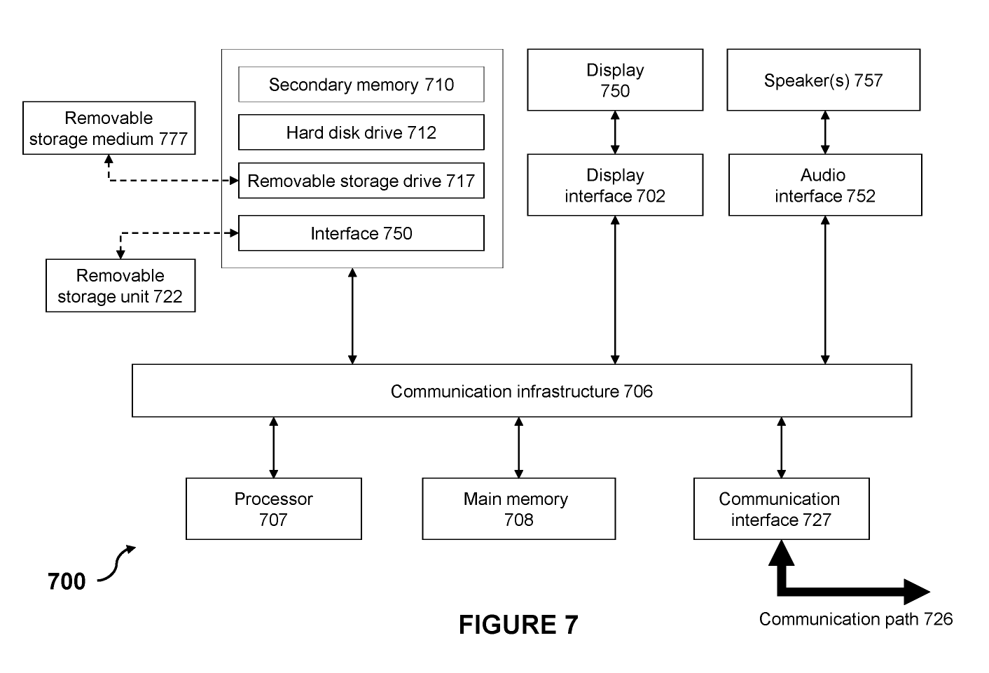

FIG. 7 depicts an exemplary computing device 700, hereinafter interchangeably referred to as a computer system 700, where one or more such computing devices 700 may be used to execute the method of FIG. 1. The exemplary computing device 700 can be used to implement the transaction system 200, 300 shown in FIGS. 2 and 3. The following description of the computing device 700 is provided by way of example only and is not intended to be limiting.

As shown in FIG. 7, the example computing device 700 includes a processor 707 for executing software routines. Although a single processor is shown for the sake of clarity, the computing device 700 may also include a multi-processor system. The processor 707 is connected to a communication infrastructure 706 for communication with other components of the computing device 700. The communication infrastructure 706 may include, for example, a communications bus, cross-bar, or network.

The computing device 700 further includes a main memory 708, such as a random access memory (RAM), and a secondary memory 710. The secondary memory 710 may include, for example, a storage drive 712, which may be a hard disk drive, a solid state drive or a hybrid drive and/or a removable storage drive 717, which may include a magnetic tape drive, an optical disk drive, a solid state storage drive (such as a USB flash drive, a flash memory device, a solid state drive or a memory card), or the like. The removable storage drive 717 reads from and/or writes to a removable storage medium 777 in a well-known manner. The removable storage medium 777 may include magnetic tape, optical disk, non-volatile memory storage medium, or the like, which is read by and written to by removable storage drive 717. As will be appreciated by persons skilled in the relevant art(s), the removable storage medium 777 includes a computer readable storage medium having stored therein computer executable program code instructions and/or data.

In an alternative implementation, the secondary memory 710 may additionally or alternatively include other similar means for allowing computer programs or other instructions to be loaded into the computing device 700. Such means can include, for example, a removable storage unit 722 and an interface 750. Examples of a removable storage unit 722 and interface 750 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 722 and interfaces 750 which allow software and data to be transferred from the removable storage unit 722 to the computer system 700.

The computing device 700 also includes at least one communication interface 727. The communication interface 727 allows software and data to be transferred between computing device 700 and external devices via a communication path 727. In various embodiments of the inventions, the communication interface 727 permits data to be transferred between the computing device 700 and a data communication network, such as a public data or private data communication network. The communication interface 727 may be used to exchange data between different computing devices 700 which such computing devices 700 form part an interconnected computer network. Examples of a communication interface 727 can include a modem, a network interface (such as an Ethernet card), a communication port (such as a serial, parallel, printer, GPIB, IEEE 1394, RJ45, USB), an antenna with associated circuitry and the like. The communication interface 727 may be wired or may be wireless. Software and data transferred via the communication interface 727 are in the form of signals which can be electronic, electromagnetic, optical or other signals capable of being received by communication interface 727. These signals are provided to the communication interface via the communication path 727.

As shown in FIG. 7, the computing device 700 further includes a display interface 702 which performs operations for rendering images to an associated display 750 and an audio interface 752 for performing operations for playing audio content via associated speaker(s) 757.

As used herein, the term “computer program product” may refer, in part, to removable storage medium 777, removable storage unit 722, a hard disk installed in storage drive 712, or a carrier wave carrying software over communication path 727 (wireless link or cable) to communication interface 727. Computer readable storage media refers to any non-transitory, non-volatile tangible storage medium that provides recorded instructions and/or data to the computing device 700 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 700. Examples of transitory or non-tangible computer readable transmission media that may also participate in the provision of software, application programs, instructions and/or data to the computing device 700 include radio or infra-red transmission channels as well as a network connection to another computer or networked device, and the Internet or Intranets including e-mail transmissions and information recorded on Websites and the like.

The computer programs (also called computer program code) are stored in main memory 708 and/or secondary memory 710. Computer programs can also be received via the communication interface 727. Such computer programs, when executed, enable the computing device 700 to perform one or more features of embodiments discussed herein. In various embodiments, the computer programs, when executed, enable the processor 707 to perform features of the above-described embodiments. Accordingly, such computer programs represent controllers of the computer system 700.

Software may be stored in a computer program product and loaded into the computing device 700 using the removable storage drive 717, the storage drive 712, or the interface 750. The computer program product may be a non-transitory computer readable medium. Alternatively, the computer program product may be downloaded to the computer system 700 over the communications path 727. The software, when executed by the processor 707, causes the computing device 700 to perform the necessary operations to execute the method 100 as shown in FIG. 1.

It is to be understood that the embodiment of FIG. 7 is presented merely by way of example to explain the operation and structure of the transaction system 100. Therefore, in some embodiments one or more features of the computing device 700 may be omitted. Also, in some embodiments, one or more features of the computing device 700 may be combined together. Additionally, in some embodiments, one or more features of the computing device 700 may be split into one or more component parts.

It will be appreciated that the elements illustrated in FIG. 7 function to provide means for performing the various functions and operations of the servers as described in the above embodiments.

When the computing device 700 is configured realise the points management system 206 to settle a transaction, the points management system 206 will have a non-transitory computer readable medium having stored thereon an application which when executed causes the points management system 206 to perform steps comprising: (i) receive a user account identifier from a device; (ii) receive a credit request from a merchant device as at least part of transaction settlement, the credit request comprising a merchant identifier and a credit amount; and (iii) determine an amount of points to be credited to a user account identified by the user account identifier and the merchant identifier, the amount of points determined in response to the credit amount.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A system configured to administer a user account, the system comprising:
at least one processor; and
at least one memory including computer program code;
the at least one memory and the computer program code configured to, with the at least one processor, cause the system at least to:
receive, from a device, a user account identifier;
receive, from a merchant device, a credit request comprising a merchant identifier and a credit amount;
determine, based on the user account identifier, at least one digital wallet associated with the user account identifier; and
determine an amount of points to be credited to the user account associated with the at least one digital wallet, the user account being determined according to the user account identifier and the merchant identifier, and the amount of points being determined in response to the credit amount.

2. The system of claim 1, wherein the system is further configured to:
receive a user selection of the at least one digital wallet and/or the user account.

3. The system of claim 1, wherein the system is further configured to credit the determined points to the user account.

4. The system of claim 3, wherein determining the amount of points to be credited, further comprising the system is configured to:
send a verification request to the device, the verification request requesting a verification input;
receive the verification input in response to the verification request from the device; and
compare the received verification input with registration data that has been registered for the at least one digital wallet and/or the user account;
wherein the step of crediting the determined points to the user account is performed in response to a result of the comparison step.

5. The system of claim 4, wherein receiving the verification input, further comprising the system is configured to:
receive the verification input from the merchant device, the verification input comprising any one or more of: a user identification code and a one-time password generated by the device using at least the user account identifier.

6. The system of claim 4, wherein the system is configured to credit the determined points to the user account responsive to the received verification input matching the registration data.

7. The system of claim 4, wherein the system is further configured to send a failure message to a device responsive to the received verification input not matching the registration data.

8. The system of claim 1, wherein the system is further configured to transmit a credit message to the device, the credit message indicative of the points credited to the user account.

9. A method for administering a user account, the method comprising:
receiving, from a device, a user account identifier;
receiving, from a merchant device, a credit request comprising a merchant identifier and a credit amount;
determining, based on the user account identifier, at least one digital wallet associated with the user account identifier; and
determining an amount of points to be credited to the user account associated with the at least one digital wallet, the user account being determined according to the user account identifier and the merchant identifier, and the amount of points being determined in response to the credit amount.

10. The method of claim 9, further comprising receiving a user selection of the at least one digital wallet and/or the user account.

11. The method of claim 9, further comprising crediting the determined amount of points to the user account.

12. The method of claim 11, wherein the step of determining the amount of points to be credited comprises:
sending, to the device, a verification request, the verification request requesting a verification input;
receiving, from the device, the verification input in response to the verification request; and
comparing the received verification input with registration data that has been registered for the at least one digital wallet and/or the user account;
wherein the step of crediting the determined points to the user account is performed in response to a result of the comparison step.

13. The method of claim 12, wherein the step of receiving the verification input comprises:
receiving, from the merchant device, the verification input, the verification input comprising any one or more of: a user identification code and a one-time password generated, by the device, using at least the user account identifier.

14. The method of claim 12, wherein the step of crediting the determined amount of points to the user account is performed responsive to the received verification input matching the registration data.

15. The method of claim 12, further comprising sending a failure message, to a device, responsive to the received verification input not matching the registration data.

16. The method of claim 9, further comprising transmitting, to the device, a credit message indicating the amount of points that have been credited to the user account.

17. The method of claim 16, wherein transmitting the credit message comprises transmitting the credit message via a near field communications link through the merchant device.

18. A non-transitory computer readable medium having stored thereon an application which when executed by a computer causes the computer to perform steps comprising:
receiving, from a device, a user account identifier;
receiving, from a merchant device, a credit request comprising a merchant identifier and a credit amount;
determining, based on the user account identifier, at least one digital wallet associated with the user account identifier; and
determining an amount of points to be credited to a user account associated with the at least one digital wallet, the user account being determined according to the user account identifier and the merchant identifier, the amount of points being determined in response to the credit amount.
